(19) United States
(12) Patent Application Publication
(10) Pub. No.: US 2026/0317058 A1
(43) Pub. Date: Oct. 15, 2026

(54) SYSTEMS AND METHODS FOR PACKING REFUSE INTO A REFUSE COLLECTION VEHICLE

(71) Applicant: The Heil Co., Chattanooga, TN (US)

(72) Inventors: Michel Fillion, Beaumont (CA); Marc Nadeau, Levis (CA); Phillip A. Kendrick, Chattanooga, TN (US); Michael Shane Peek, Pisgah, AL (US)

(21) Appl. No.: 19/176,984

(22) Filed: Apr. 11, 2025

(51) Int. Cl. B65F 3/20

(52) U.S. Cl. CPC B65F 3/201

(57) ABSTRACT

A packer for a refuse collection vehicle includes a housing or framework configured to couple to the refuse collection vehicle: a prime mover assembly including a prime mover; at least one rack and cog gear assembly driveably coupled to the prime mover assembly through a shaft and at least partially enclosed in the housing; and a packer blade. The at least one rack and cog gear assembly includes a cog gear interfaced with a rack gear and configured to impart linear force to the rack gear based on rotation of the cog gear on the shaft. The packer blade is coupled to the rack gear and configured to move refuse based on movement of the rack gear in response to the linear force.

### TECHNICAL FIELD

This disclosure relates to the field of refuse collection, storage, and compaction.

### BACKGROUND

Refuse collection vehicles are typically used to pick up quantities of refuse (e.g., garbage, waste, recyclables, etc.) for hauling to a designated area, such as a landfill, transfer station, or material recovery facility. These vehicles hold the refuse in a relatively large storage container supported on the vehicle chassis. Many refuse collection vehicles include an onboard system—colloquially called a “packer”—that compacts the refuse within the storage container. Compacting the refuse increases the volume that the vehicle can hold in the storage container before the vehicle must travel to the designated area and eject the load.

### SUMMARY

In an example implementation, a refuse collection vehicle includes a vehicle chassis defining a forward direction and a rearward direction of travel; a refuse body on the vehicle chassis; a packer coupled to the refuse body; and a controller. The refuse body includes a hopper and a storage container rearward of the hopper. The storage container defines an enclosed volume for containing waste. The packer includes at least one rack and cog gear assembly driveably coupled to a prime mover, with each rack and cog gear assembly including a cog gear interfaced with a rack gear; and a packer blade coupled to the at least two rack gears. The controller is communicably coupled to the prime mover and configured to perform operations including operating the prime mover to rotatably drive the at least one cog gear interfaced with the at least one rack gear; and based on the rotation of the at least one cog gear, linearly driving the at least one rack gears in a linear direction to urge the packer blade to transfer waste from the hopper into the storage container.

In an aspect combinable with the example implementation, the at least one rack and cog gear assembly includes at least two rack and cog gear assemblies, with each of the at least two rack and cog gear assemblies including the cog gear interfaced with the rack gear.

In another aspect combinable with one, some, or all of the previous aspects, the packer includes a shaft coupled with the prime mover, and the at least two cog gears are rigidly mounted on the shaft and separated by a gap.

In another aspect combinable with one, some, or all of the previous aspects, the gap is defined by a dimension associated with a thickness of a cog tooth on one of the at least two cog gears.

In another aspect combinable with one, some, or all of the previous aspects, the at least two cog gears include a first cog gear rigidly mounted on the shaft and including a plurality of first cog gear teeth; and a second cog gear rigidly mounted on the shaft and including a plurality of second cog gear teeth.

In another aspect combinable with one, some, or all of the previous aspects, the second cog gear is radially offset from the first cog gear such that each of the second cog gear teeth is radially offset from a radially adjacent first cog gear tooth by a radial offset.

In another aspect combinable with one, some, or all of the previous aspects, each first cog gear tooth is radially spaced apart from adjacent first cog gear teeth on the first cog gear by a radial distance, and each second cog gear tooth is radially spaced apart from adjacent second cog gear teeth on the second cog gear by the radial distance.

In another aspect combinable with one, some, or all of the previous aspects, the radial offset is half of the radial distance.

In another aspect combinable with one, some, or all of the previous aspects, the at least two rack gears include a first rack gear coupled to the packer blade and including a plurality of first rack gear teeth; and a second rack gear coupled to the packer blade and including a plurality of second rack gear teeth.

In another aspect combinable with one, some, or all of the previous aspects, each of the second rack gear teeth is linearly offset from a side adjacent first rack gear tooth by a linear offset.

In another aspect combinable with one, some, or all of the previous aspects, each of the first and second rack gears includes a plurality of shoulder slopes defined between adjacent first rack teeth and adjacent second rack teeth, respectively.

In another aspect combinable with one, some, or all of the previous aspects, the linear direction is a first linear direction in the rearward direction of travel, and the operations include operating the prime mover to rotatably drive the at least one cog gear interfaced with the at least one rack gear; and based on the rotation of the at least one cog gear, linearly driving the at least one rack gear in a second linear direction to urge the packer blade into a reset position.

In another aspect combinable with one, some, or all of the previous aspects, the second linear direction is opposite the first linear direction and in the forward direction of travel.

In another example implementation, a method of managing waste includes operating a refuse collection vehicle to move to a waste collection location. The refuse collection vehicle includes a vehicle chassis defining a forward direction and a rearward direction of travel; a refuse body on the vehicle chassis; and a packer coupled to the refuse body. The refuse body includes a hopper; a storage container rearward of the hopper and defining an enclosed volume for containing waste; and a lift configured to service a refuse container proximate the vehicle. The packer includes at least one rack and cog gear assembly driveably coupled to a prime mover, where the at least one rack and cog gear assembly includes a cog gear interfaced with a rack gear; and a packer blade coupled to the at least two rack gears. The method includes operating the lift to engage the container, lift the container, and deposit waste from the container into the hopper; operating the prime mover to rotatably drive the at least one cog gear interfaced with the at least one rack gear; and based on the rotation of the at least one cog gear, linearly driving the at least one rack gear in a linear direction to urge the packer blade to transfer waste from the hopper into the storage container.

In an aspect combinable with the example implementation, the at least one rack and cog gear assembly includes at least two rack and cog gear assemblies, and each of the at least two rack and cog gear assemblies including the cog gear interfaced with the rack gear.

Another aspect combinable with one, some, or all of the previous aspects includes operating the prime mover to rotatably drive the at least two cog gears interfaced with the at least two rack gears.

In another aspect combinable with one, some, or all of the previous aspects, operating the prime mover to rotatably drive the at least two cog gears includes rotating a shaft with the prime mover to rotate the at least two cog gears rigidly mounted on the shaft and separated by a gap.

Another aspect combinable with one, some, or all of the previous aspects includes rotating the shaft with the prime mover to rotate the at least two cog gears rigidly mounted on the shaft to engage the at least to rack gears without cross-engaging the at least two cog gears with the at least two rack gears due to the gap that is defined by a dimension associated with a thickness of a cog tooth on one of the at least two cog gears.

In another aspect combinable with one, some, or all of the previous aspects, operating the prime mover to rotatably drive the at least two cog gears includes operating the prime mover to rotatably drive a first cog gear rigidly mounted on the shaft and including a plurality of first cog gear teeth; and operating the prime mover to rotatably drive a second cog gear rigidly mounted on the shaft and including a plurality of second cog gear teeth.

In another aspect combinable with one, some, or all of the previous aspects, the second cog gear is radially offset from the first cog gear such that each of the second cog gear teeth is radially offset from a radially adjacent first cog gear tooth by a radial offset.

In another aspect combinable with one, some, or all of the previous aspects, each first cog gear tooth is radially spaced apart from adjacent first cog gear teeth on the first cog gear by a radial distance, and each second cog gear tooth is radially spaced apart from adjacent second cog gear teeth on the second cog gear by the radial distance.

In another aspect combinable with one, some, or all of the previous aspects, the radial offset is half of the radial distance.

In another aspect combinable with one, some, or all of the previous aspects, linearly driving the at least two rack gears includes linearly driving a first rack gear coupled to the packer blade and including a plurality of first rack gear teeth; and linearly driving a second rack gear coupled to the packer blade and including a plurality of second rack gear teeth.

In another aspect combinable with one, some, or all of the previous aspects, each of the second rack gear teeth is linearly offset from a side adjacent first rack gear tooth by a linear offset.

In another aspect combinable with one, some, or all of the previous aspects, each of the first and second rack gears includes a plurality of shoulder slopes defined between adjacent first rack teeth and adjacent second rack teeth, respectively, and the method includes facilitating egress of waste from the at least two rack gears, down at least one of the plurality of shoulder slopes, to a sump area under the at least two rack and cog gear assemblies.

In another aspect combinable with one, some, or all of the previous aspects, the linear direction is a first linear direction in the rearward direction of travel, and the method includes operating the prime mover to rotatably drive the at least one cog gear interfaced with the at least one rack gear; and based on the rotation of the at least one cog gear, linearly driving the at least one rack gear in a second linear direction to urge the packer blade into a reset position.

In another aspect combinable with one, some, or all of the previous aspects, the second linear direction is opposite the first linear direction and in the forward direction of travel.

In another example implementation, a packer for a refuse collection vehicle includes a housing or framework configured to couple to the refuse collection vehicle: a prime mover assembly including a prime mover; at least one rack and cog gear assembly driveably coupled to the prime mover assembly through a shaft and at least partially enclosed in the housing; and a packer blade. The at least one rack and cog gear assembly includes a cog gear interfaced with a rack gear and configured to impart linear force to the rack gear based on rotation of the cog gear on the shaft. The packer blade is coupled to the rack gear and configured to move refuse based on movement of the rack gear in response to the linear force.

In an aspect combinable with the example implementation, the at least one rack and cog gear assembly includes: a first rack and cog gear assembly that includes a first rack gear and a first cog gear; and a second rack and cog gear assembly that includes a second rack gear and a second cog gear.

In another aspect combinable with one, some, or all of the previous aspects, the first and second cog gears are rigidly mounted on the shaft and separated by a gap.

In another aspect combinable with one, some, or all of the previous aspects, the gap is defined by a dimension associated with a thickness of a cog tooth on one of the first or second cog gears.

In another aspect combinable with one, some, or all of the previous aspects, the first cog gear is rigidly mounted on the shaft and includes a plurality of first cog gear teeth; and the second cog gear is rigidly mounted on the shaft and includes a plurality of second cog gear teeth.

In another aspect combinable with one, some, or all of the previous aspects, the second cog gear is radially offset from the first cog gear such that each of the second cog gear teeth is radially offset from a radially adjacent first cog gear tooth by a radial offset.

In another aspect combinable with one, some, or all of the previous aspects, each first cog gear tooth is radially spaced apart from adjacent first cog gear teeth on the first cog gear by a radial distance, and each second cog gear tooth is radially spaced apart from adjacent second cog gear teeth on the second cog gear by the radial distance.

In another aspect combinable with one, some, or all of the previous aspects, the radial offset is half of the radial distance.

In another aspect combinable with one, some, or all of the previous aspects, the first rack gear is coupled to the packer blade and includes a plurality of first rack gear teeth; and the second rack gear is coupled to the packer blade and includes a plurality of second rack gear teeth.

In another aspect combinable with one, some, or all of the previous aspects, each of the second rack gear teeth is linearly offset from a side adjacent first rack gear tooth by a linear offset.

In another aspect combinable with one, some, or all of the previous aspects, each of the first and second rack gears includes a plurality of shoulder slopes defined between adjacent first rack teeth and adjacent second rack teeth, respectively.

In another aspect combinable with one, some, or all of the previous aspects, the prime mover assembly includes an electric motor and a gear box.

Particular implementations of the subject matter described in this disclosure can be implemented so as to realize one or more material advantages. For example, implementations of the subject matter described in this disclosure can more efficiently move waste into a storage container of a refuse collection vehicle, including, for example, thin and unrigid plastic waste such as plastic bags without malfunctioning.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 is a side view of a side-loading refuse collection vehicle that includes a packer according to the present disclosure.

FIGS. 2A-2D are views of portions of the refuse collection vehicle of FIG. 1 according to the present disclosure.

FIGS. 3A-3D are views of an example implementation of a packer (including views of portions of the packer) according to the present disclosure.

FIGS. 4A-4C are views of the example implementation of the packer of FIGS. 3A-3D according to the present disclosure.

FIG. 5 is a diagram depicting an example implementation of a control system for controlling one or more operational components of a refuse collection vehicle.

### DETAILED DESCRIPTION

Implementations of the present disclosure feature techniques for determining a state of a refuse collecting system based on the load applied by or to a packer compacting the materials within a storage container. In some implementations, for example, monitoring and analyzing packer load facilitates determining the volumetric fullness of the storage container and/or determining whether the packer is operating in an idle state (e.g., where the packer is operating but not performing compaction). The inventor(s) associated with this disclosure have discovered that fullness detection techniques accounting for packer load are more accurate than techniques that focus solely on the weight of the stored materials or the number of service events. Similarly, the inventor(s) have discovered that significant energy savings can be achieved by a control scheme that incorporates techniques for detecting and deactivating an idling packer.

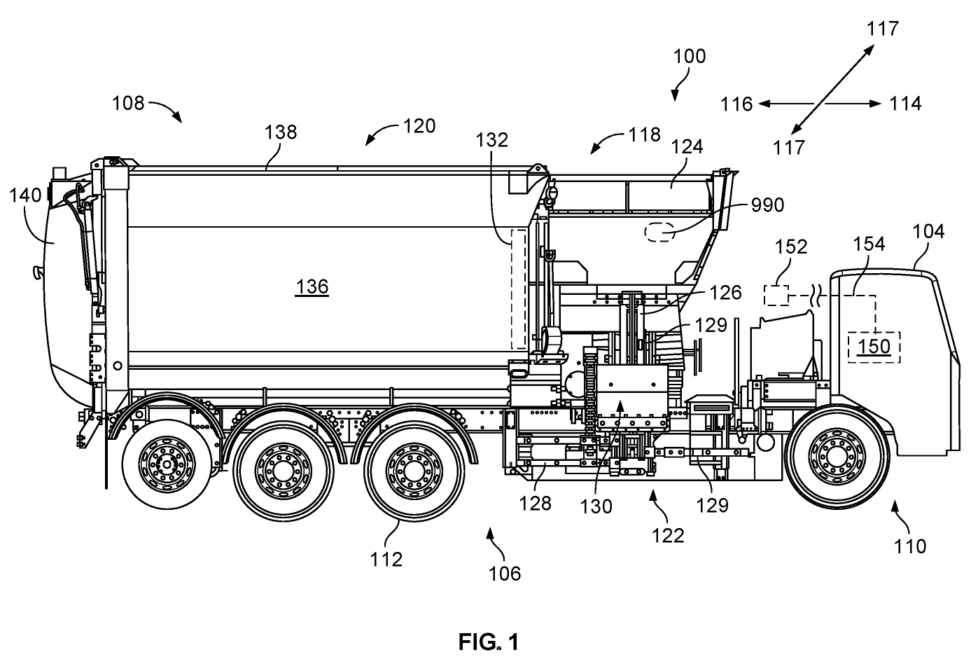

FIG. 1 depicts a vehicle 100 for collecting, packing, and transporting refuse (e.g., garbage) to a designated area, such as a landfill, transfer station, or material recovery facility. Refuse collection vehicles such as vehicle 100 are often described colloquially as garbage collection vehicles or just “garbage trucks.”

Refuse collection vehicle 100 includes a cab 104, a chassis 106, and a refuse collecting body 108. Cab 104 includes a compartment for a driver of vehicle 100. The compartment is equipped with controls that enable the driver to operate various elements of chassis 106 and body 108 and one or more displays that enable the driver to monitor such elements. Chassis 106 includes a power train 110 (e.g., a diesel, CNG, or electric power train). Power train 110, which includes a prime mover and a drivetrain, converts and transfers motive power to the wheels 112 that move vehicle 100 on a road surface along a forward direction of travel 114 (or front or forward 114) and a rearward direction of travel 116 (rear or rearward 116). The direction across vehicle 100 and orthogonal to the forward/rearward directions is a transverse direction 117.

Refuse collecting body 108 includes an intake system 118, a storage container 120, a packer 130, an ejector 132, and a tailgate 140. Intake system 118 includes a lift 122 and a hopper 124. Lift 122 is operable to transfer the contents of residential refuse containers into storage container 120 via hopper 124. In this example, lift 122 includes a side-loading arm assembly including a reach (not shown), a mast 126, and a grabber 128. During use, when vehicle 100 pulls up to a residential refuse container, lift 122 performs a dump-cycle “service event” that includes: (i) moving the grabber 128 in the transverse direction away from the vehicle and toward the container via the reach; (ii) engaging (e.g., grasping) the container with the grabber 128; (iii) moving the grabber 128 with the container back toward the vehicle via the reach; (iv) raising the grabber 128 and the container vertically along the mast 126; and (v) dumping the contents of the container into the hopper 124. A set of one or more lift sensors 129 monitor operation of lift 122 during such a dump cycle.

Storage container 120 provides an enclosed refuse-containing volume defined (in part) by a floor 134, lateral side walls 136, and a cover 138. Ejector 132 features a movable panel that provides a front wall of the volume, separating storage container 120 from hopper 124. Tailgate 140 provides the volume’s rear wall.

In this example, packer 130 features a gear drive assembly (shown in more detail herein) that resides within hopper 124 and is operable to urge refuse 990 deposited in the hopper 124 into the storage container 120. Generally, and as described in more detail herein, the gear drive assembly can include a rack and pinion gear (or modified rack and pinion gear) assembly, with example implementations including two or more pinion (or cog) gears that rotatably drive corresponding rack gear(s) rearward 116 to urge a packer blade (coupled to the rack gear(s)) rearward 116 as well. Refuse in the hopper 124 can then be urged by the packer blade into the storage container 120.

In some aspects, the rack and pinion gear (or modified rack and pinion gear) assembly comprises an electrically-driven linear packer comprises cog gear(s) that ride on a rotating shaft driven, e.g., by an electric motor (optionally through a packer gear box). In some aspects, the example implementation of the rack and pinion gear assembly includes two rack gears (e.g., two parallel rack gears arranged linearly and generally parallel to directions 116 and 114). In some aspects, through the utilization of two or more rack gears (and correspondingly, two or more pinion or cog gears) rather than a single rack gear (and single pinion or cog gear), a peak load on each cog gear (and cog tooth) is reduced, improving operational efficiency and reducing mechanical breakdown of the packer 130.

As explained in more detail herein, the packer 130 can also include a guide track on which the one or more rack gears are positioned to manage lifting the front of the packer blade at extension and to prevent (or reduce) racking. Example implementations of the packer 130 utilize a pack-through ejector panel concept with a guillotine door, with all of the features and advantages of that system (e.g., common chain to close door then pull the ejector rearward).

Waste in the hopper 124 is conveyed by the packer 130 rearward 116, where it passes through an aperture in the ejector 132 and enters the enclosed volume of the storage container 120. As waste builds up in the storage container 120, operation of the packer 130 not only transfers new waste from the hopper 124 into the storage container 120 but also pushes the new waste against the existing waste already in the storage container 120. Compacting the waste in this manner decreases its volume and increases the storage capacity of the storage container.

In one exemplary (but non-limiting) use-case, vehicle 100 traverses a refuse collection route including numerous (e.g., hundreds) of service stops to pick up residential refuse containers, dump waste into the hopper 124, transfer waste from the hopper 124 into the storage container 120 and compact the waste within the storage container 120. After completing all or a portion of a collection route, vehicle 100 travels to a designated area and ejects the waste from the storage container 120 using the ejector 132. To eject a load of waste, tailgate 140 pivots from a closed position (as shown in FIG. 1) to an open position, and the panel of ejector 132 moves rearward, pushing the load through the tailgate opening (an “eject event”). A set of one or more ejector sensors 133 monitor operation of ejector 132 during such an ejection event.

As shown in FIG. 1, vehicle 100 further includes a controller 150 that controls the operation of packer 130. Controller 150 is communicatively coupled with a packer motor (shown in other figures) and a packer load sensor 152 via an information network 154 (shown schematically in this figure). Packer load sensor 152 monitors a load imparted on or by the packer 130 and outputs packer load data corresponding to the same. As one example, packer load sensor 152 may take the form of a torque measuring device (e.g., a rotary or reaction torque transducer, a load cell, etc.) that measures torque applied by a prime mover (e.g., packer motor) of rack and pinion gear assembly to another packer component. As another example, packer load sensor 152 may take the form of a device that measures certain operating characteristics/qualities of the prime mover (e.g., a current or voltage measuring device). Packer load sensor 152 provides a stream of packer load data values. In this example, the data stream includes a plurality of packer load data values ranging between a lower limit (e.g., 0) and an upper limit (e.g., 1,000). Additionally, in this example, packer load sensor 152 outputs packer load data values according to a predetermined sample rate (e.g., 1 Hz, 10 Hz, or 100 Hz).

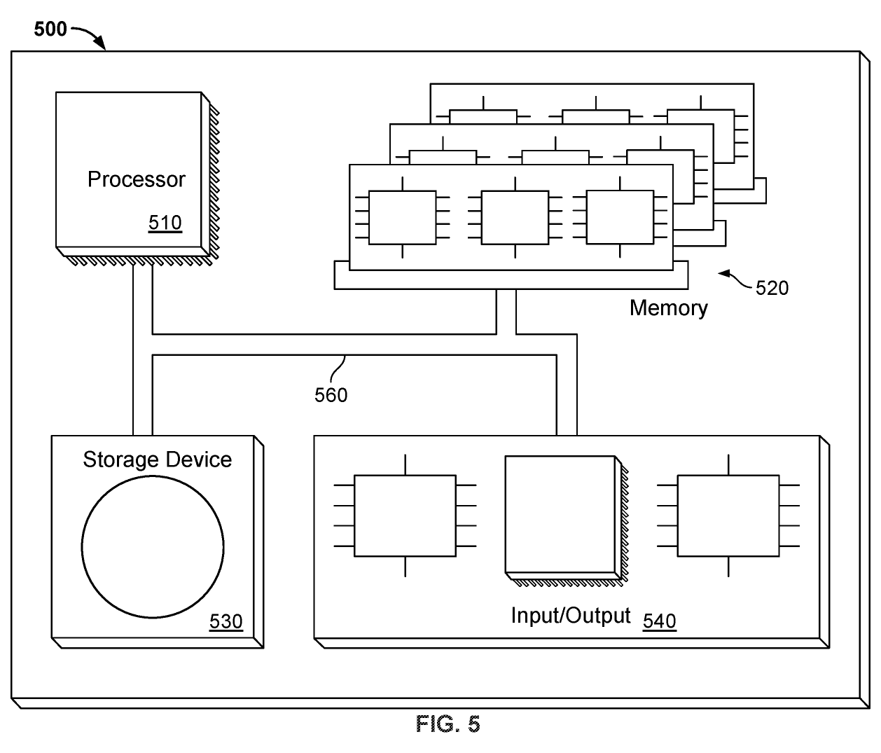

In this example, controller 150 is provided in the form of a programmable logic controller (PLC) with integral data input/output, memory, and processing components (shown schematically in FIG. 5), and information network 154 includes an onboard wired data bus. Controller 150 issues command signals through the information network 154 that cause the packer motor to operate or not operate. Controller 150 performs control schemes and issues control commands based on packer load data received, via information network 154, from packer load sensor 152. For example, controller 150 can perform a container-fullness control scheme and a packer operation scheme (as described herein). Controller 150 also provides, via information network 154, information (e.g., data, alerts, etc.) regarding the operation of refuse collecting body 108 to a user interface system viewable by a human operator in the vehicle’s cab 104.

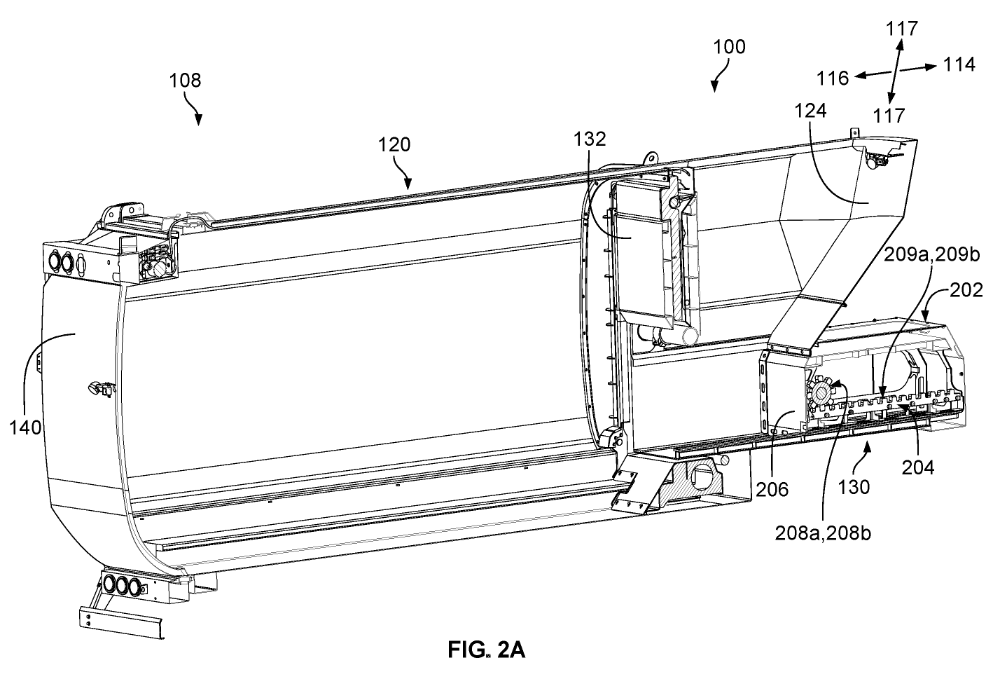

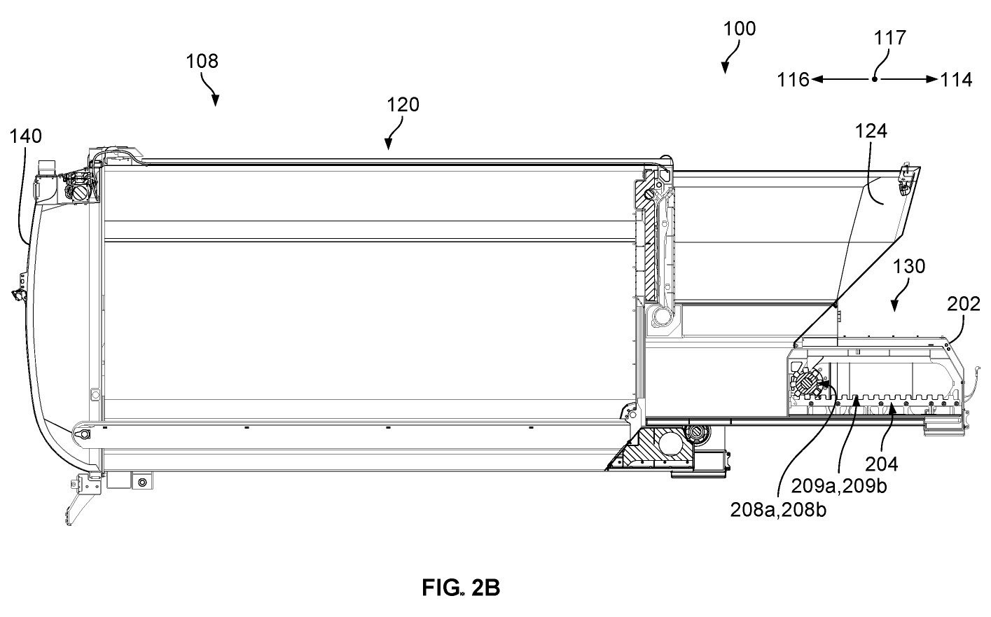

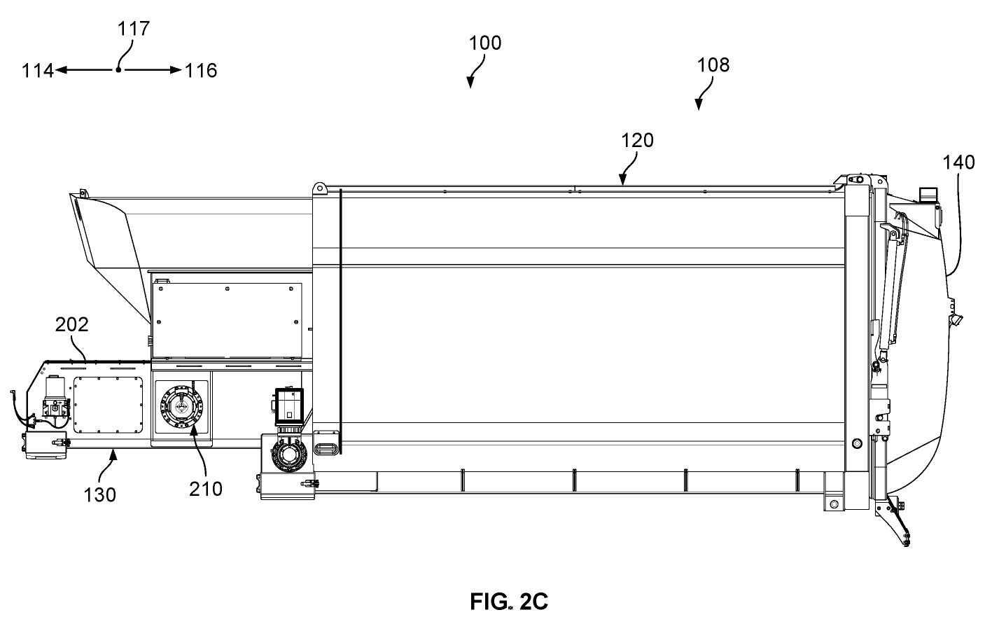

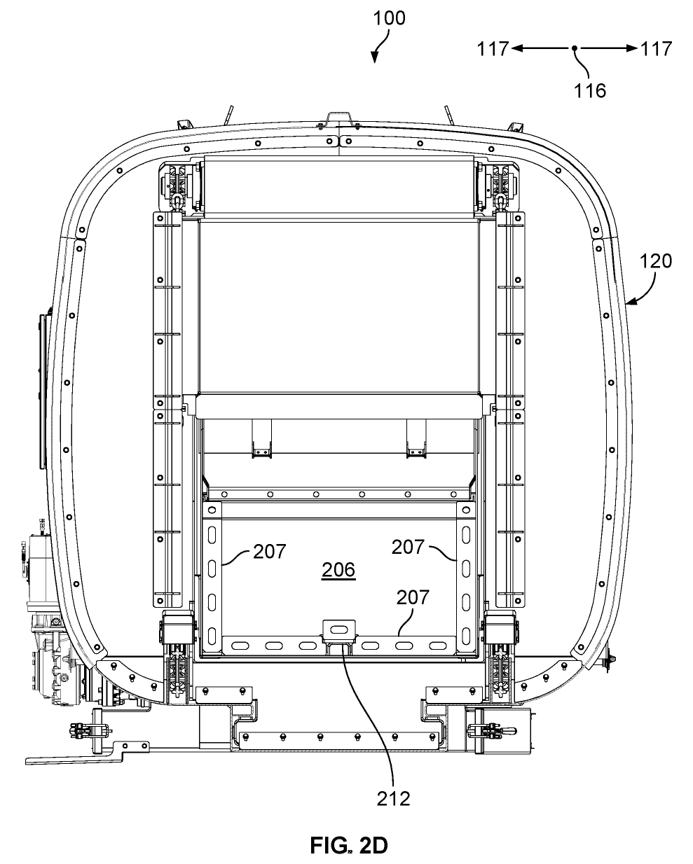

FIGS. 2A-2D are views of portions of the refuse collection vehicle 100 of FIG. 1 according to the present disclosure. FIG. 2A shows an isometric sectional view (taken along the directions 116-114) of portions of the refuse collection vehicle 100, including the packer 130. FIG. 2B shows a first (or right) side sectional view (taken along the directions 116-114) of portions of the refuse collection vehicle 100, including the packer 130. FIG. 2C shows a second (or left) side sectional view (taken along the directions 116-114) of portions of the refuse collection vehicle 100, including the packer 130. FIG. 2D shows a rear sectional view (taken parallel to transverse 117) of portions of the refuse collection vehicle 100, including a packer blade 206.

As generally shown in these figures, packer 130 is positioned near a front portion of the refuse collection vehicle 100, such as between the refuse collecting body 108 and the cab 104; however, packer 130 can be considered part of either of the refuse collecting body 108 or the cab 104 (or separate from both) depending on the structure of the refuse collection vehicle 100. In this example, the packer 130 includes a housing (or framework) 202 that supports and at least partially encloses certain components of the packer 130 (such as a packer gear assembly 204). Enclosure of certain components can, for example, protect such components from stray refuse, which can clog or interfere with the operation of such components of the packer 130. Thus, reference to the housing 202 or framework 202 includes reference to a structural framework that supports the packer 130 on (and couples it to) the refuse collection vehicle 100, as well as an enclosure that at least partially encloses the packer 130.

In this example implementation, the packer gear assembly 204 comprises a rack and pinion (or modified rack and pinion) gear assembly that, e.g., utilizes one or more rack gears that interface with corresponding pinion (or cog) gear(s) driven by a packer prime mover 210. In the example implementation shown in FIGS. 2A and 2B, the packer gear assembly 204 includes dual rack gears 209a and 209b, which interface with corresponding dual pinion (or cog) gears 208a and 208b. As explained in more detail herein, the dual pinion (or cog) gears 208a and 208b ride on and are driven (e.g., rotated) by a shaft coupled to the packer prime mover 210; rotation of the gears 208a and 208b on the shaft drives (linearly) the dual rack gears 209a and 209b (e.g., simultaneously), which in turn urges packer blade 206 (along, optionally, with one or more components of the framework 202) rearward 116 to push refuse from the hopper 124 into the storage container 120. Upon reversal of rotation of the shaft coupled to the packer prime mover 210; rotation of the gears 208a and 208b on the shaft drives (linearly) the dual rack gears 209a and 209b (e.g., simultaneously) in the direction 114, which in turn urges packer blade 206 (along, optionally, with one or more components of the framework 202) forward 114 to reset and be ready for additional refuse in the hopper 124.

As shown specifically in FIG. 2D, the packer blade 206 (which is coupled directly or indirectly) to the dual rack gears 209a and 209b faces a rear end of the refuse collection vehicle 100. A guide track 212 extends under the dual rack gears 209a and 209b and, as explained in more detail herein, can ensure stability (or reduce instability) of the dual rack gears 209a and 209b during operation of the packer gear assembly 204.

In some aspects, the packer blade 206 is positioned to urge or push refuse from the hopper 124 into the storage container 120 during operation of the packer gear assembly 204. The packer blade 206 also acts as a deterrent or barrier to entry of refuse into the housing 202 of the packer 130 and, more specifically, a barrier to refuse engaging the packer gear assembly 204. For example, excess refuse can disrupt operation of the packer gear assembly 204 if present and in contact with, e.g., one or more of the cog gears 208a and 208b and the dual rack gears 209a and 209b. Thus, as shown in these figures, when the packer blade 206 is in a retracted position (as in FIG. 2A for instance), refuse is prevented from migrating from the hopper 124 into the housing 202 by the packer blade 206.

Optionally and as shown in FIG. 2D, scrapers 207 can be mounted on or otherwise coupled to one or more side edges of the packer blade 206. In some aspects, the scrapers 207 (shown here mounted on left, right, and bottom edges of the blade 206) can further reduce an amount of refuse that migrates from the hopper 124 into the housing 202. For example, the scrapers 207, in some aspects, can be welded or otherwise attached to the packer blade 206 to create a tighter seal (e.g., to fill a gap) between the packer blade 206 and sides of the hopper 124 (or any enclosure into which the packer blade 206 extends). In operation of the packer 130 (and movement of the packer blade 206 in particular), the scrapers 207 can help urge refuse along the sides of the hopper 124 into the storage container 120 (during a “push in” movement of the packer blade 206 from forward 114 to rearward 116) while preventing excess refuse (refuse not transferred from the hopper 124 to the storage container 120) from being drawn into or otherwise migrating to the housing 202 during a “pull out” (movement of the packer blade 206 from rearward 116 to forward 114).

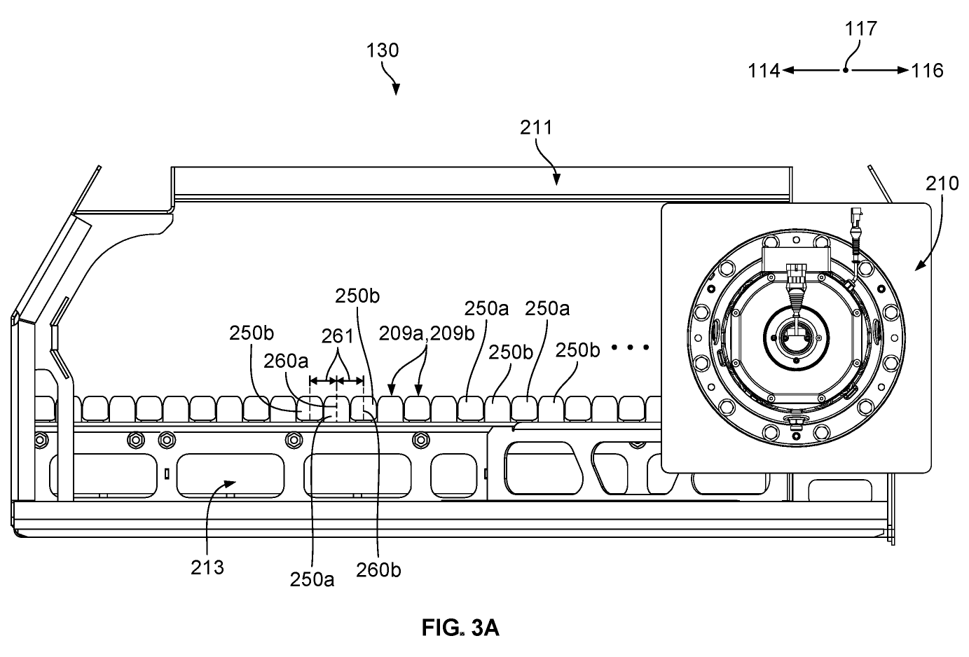

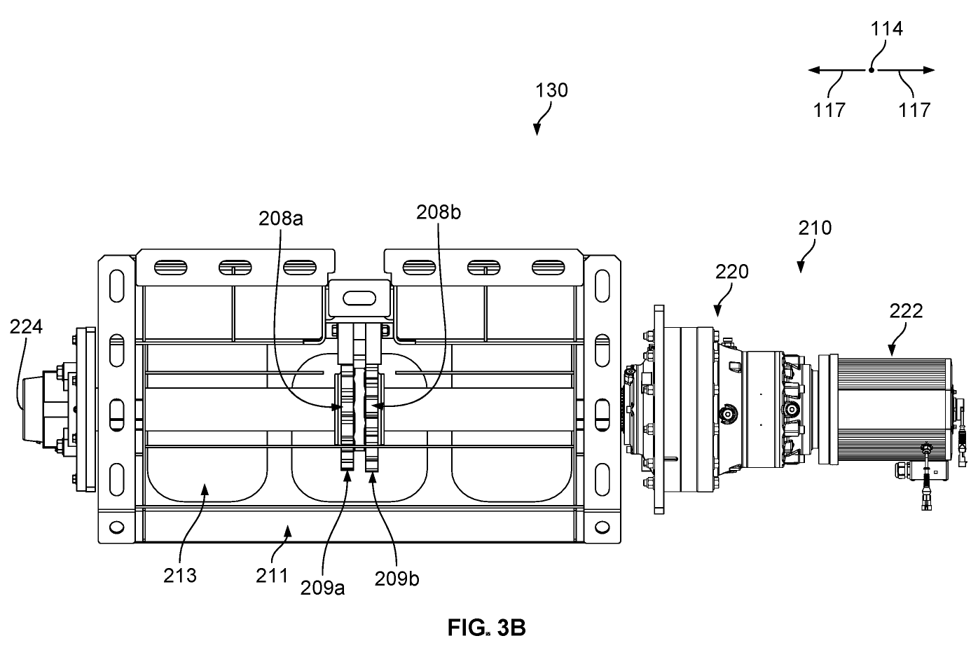

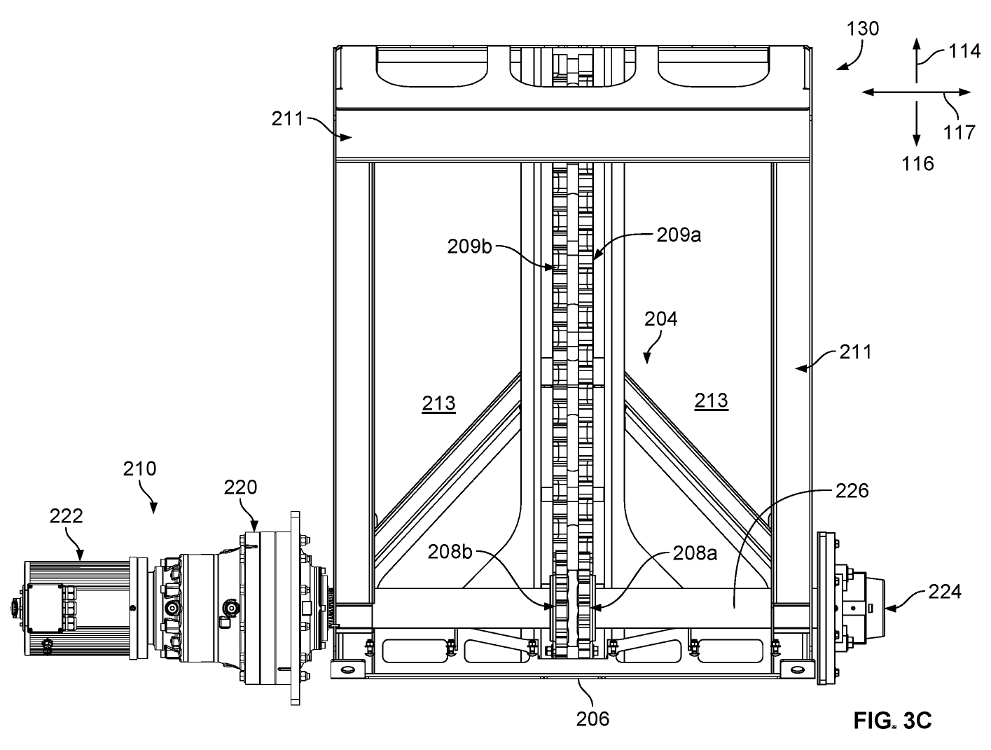

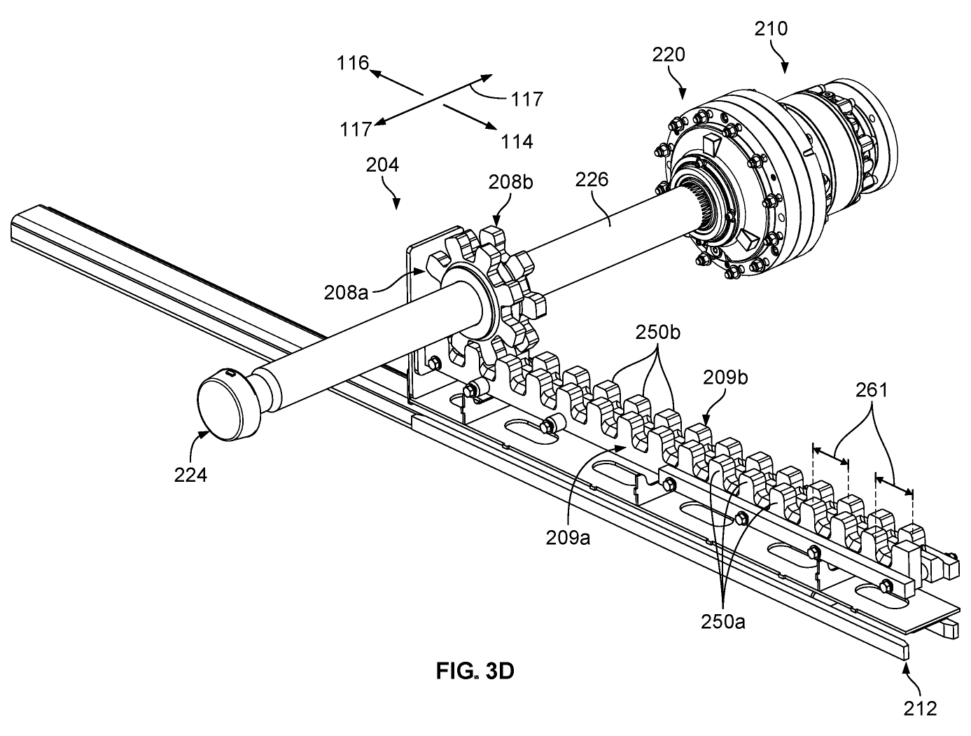

FIGS. 3A-3D are views of an example implementation of the packer 130 (including views of portions of the packer 130) according to the present disclosure. FIG. 3A shows a left side view of at least a portion of the packer 130. FIG. 3B shows a front side view of at least a portion of the packer 130. FIG. 3C shows a top view of at least a portion of the packer 130. FIG. 3D shows an isometric view of at least a portion of the packer 130. As shown in one or more of these figures, the example implementation of the packer 130 further includes a sled 211 (that is comprised of attached structural members) that, in some aspects, is coupled (directly or indirectly) to the dual rack gears 209a and 209b, as well as the packer blade 206 to create or define a unitized and movable structure that linearly translates in and between the directions 114 and 116 during operation of the packer 130 (during push in and pull out operations). As shown in FIG. 3A specifically, a sump 213 is defined underneath at least a portion of the sled 211 (and under the rack gears 209a and 209b) and enclosed by the housing 202. In some aspects, this sump 213 can hold and/or retain excess refuse that migrates into the housing 202 for later removal.

In the illustrated implementation of these figures, the packer prime mover 210 include a motor 222 (e.g., electric) and a gearbox 220. A shaft 226 (on which the cog gears 208a and 208b are rigidly mounted and ride on, but do not spin on) is coupled to the motor 222 through the gearbox 220. In some aspects, the gearbox 220, which can function to rotate the shaft 226 at a particular or desired rotational speed in response to the operation of the motor 222, can be eliminated. In such alternatives, the shaft 226 can be part of a motor shaft that rotates directly by motor operation. In short, the present disclosure contemplates that rotational speed and rotational direction (e.g., clockwise or counterclockwise to effectuate a pull out operation or push in operation, respectively, in this example), of the shaft 226 can be adjusted or controlled by the gearbox 220 through operation of the motor 222 or directly by the motor 222.

As shown in FIGS. 3A and 3D, each of the dual rack gears 209a and 209a include multiple gear teeth that, in operation, engage with and receive a force from, the cog gears 208a and 208b, respectively. Rack gear 209a includes gear teeth 250a, while rack gear 209b includes gear teeth 250b. As shown here and explained more fully herein, rack teeth 250a and rack teeth 250b can be linearly offset so that an offset distance 261 exists between a vertical centerline 260a of a particular rack tooth 250a and a vertical centerline 260b of immediately (side) adjacent rack teeth 250b (specifically illustrated in FIG. 3A). These offset distances 261 (which are defined between pairs of gear teeth on the dual rack gears 209a and 209b) can provide for more efficient operation and, for example, force transfer from the cog gears 208a and 208b and the rack gears 209a and 209b, as compared to dual rack gears in which no offset distance was present.

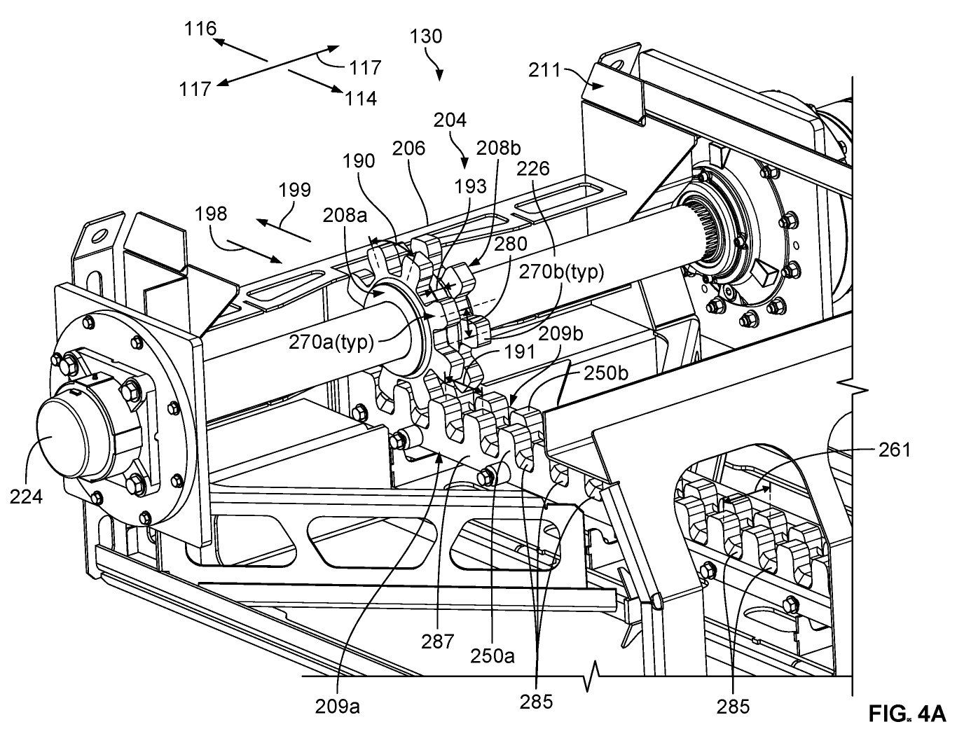

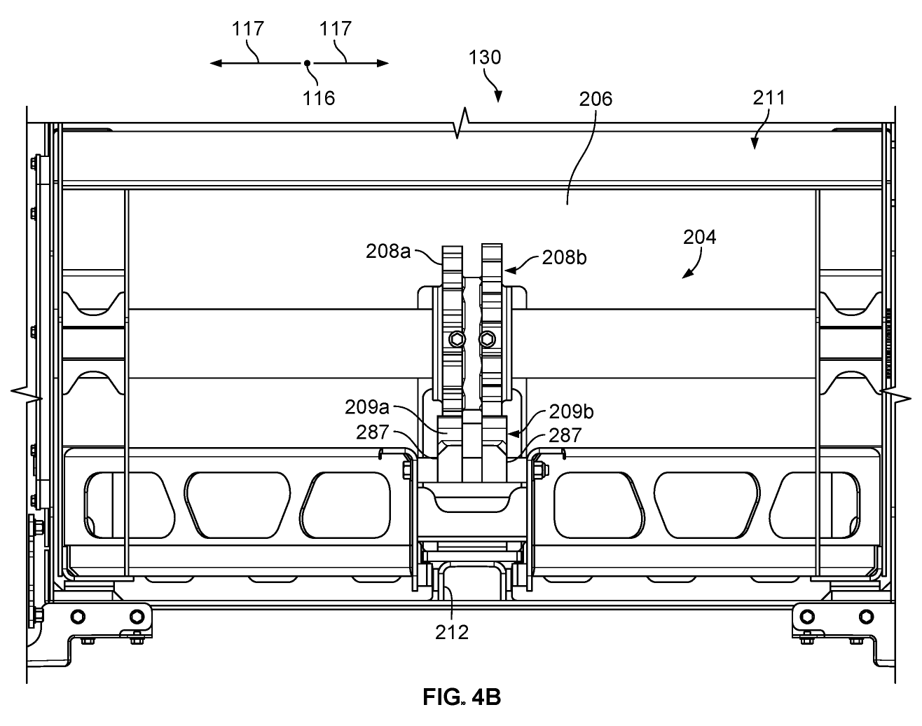

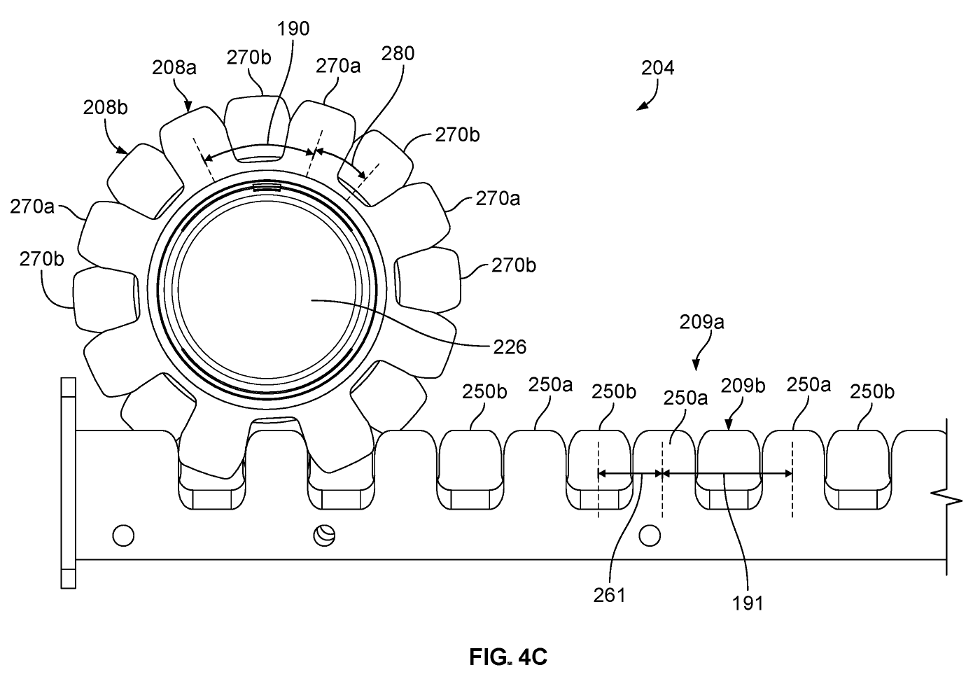

Turning to FIGS. 4A-4C. these figures show magnified of the example implementation of the packer 130 of FIGS. 3A-3D according to the present disclosure. FIG. 4A shows a magnified isometric view of a portion of the packer 130 that includes portions of the cog gears 208a and 208b, as well as the rack gears 209a and 209b, and the interface therebetween. FIG. 4B shows a magnified view from the front end (direction 116) of the packer gear assembly 204. FIG. 4C shows a magnified view of the offsets of the packer gear assembly 204.

As shown in FIGS. 4A and 4C and previously described, the dual rack gears 209a and 209b include offset distances 261 between corresponding rack teeth 250a and 250b; thus, no pair of teeth 250a and 250b are exactly side-by-side in this example but are spaced apart (in the directions 114 and 116) by the offset distance 261. As further shown in this figure, adjacent rack teeth 250a, as well as adjacent rack teeth 250b, on respective rack gears 209a and 209b, are spaced apart from each other by an offset distance 191. This offset distance 191 can be determined, for example, by a size or design of respective cog teeth 270a (on cog gear 208a) and cog teeth 270b (on cog gear 208b). For example, the offset distance 191 can be designed or selected to ensure proper contact between the cog teeth and rack teeth during operation of the packer gear assembly 204, such that proper force 199 (in a push out operation) or force 198 (in a pull in operation) are applied from the cog gears 208a and 208b to the rack gears 209a and 209b.

In this example implementation, the offset distance 191 can allow for a shoulder slope 285 to be formed between adjacent rack teeth (250a and 250b). In some aspects, this shoulder slope 285 is formed on both lateral sides of each rack gear 209a and 209b; alternatively, the shoulder slope 285 can be formed only on the external sides 287 of the rack gears 209a and 209b. In some aspects, such as when refuse becomes engaged with the rack teeth 250a and/or 250b, the shoulder slope 285 provides for an outlet through or on which the engaged refuse can drop from the rack gears 209a and/or 209b (e.g., into the sump 213). Once collected in the sump 213, the refuse can be removed from the packer 130.

As further shown in the example of FIG. 4A, there can be a radial offset 280 between adjacent cog teeth 270a and 270b, as well as a gap 193 between cog gear 208a and cog gear 208b. The gap 193, in some aspects, can have a width about the same as or equal to a thickness of a cog tooth 270a or 270b so as to reduce or prevent cross-interface between cog gears 208a and 208b and rack gears 209a and 209b. For example, cross-interfacing of cog teeth 270a with rack teeth 250b can damage or cause a malfunction to the packer gear assembly 204.

As shown, no pair of teeth 270a and 270b are exactly radially side-by-side in this example but are spaced apart by the radial offset 280. As further shown in this figure, adjacent cog teeth 270a, as well as adjacent cog teeth 270b, on respective cog gears 208a and 208b, are spaced apart from each other by a radial offset 190. This radial offset 190 can be determined, for example, by a size or design of respective rack teeth 250a (on rack gear 209a) and rack teeth 250b (on rack gear 209b). For example, the radial offset 190 can be designed or selected to ensure proper contact between the cog teeth and rack teeth during operation of the packer gear assembly 204, such that proper force 199 (in a push out operation) or force 198 (in a pull in operation) are applied from the cog gears 208a and 208b to the rack gears 209a and 209b.

In this example implementation, the radial offsets 280 and 190 can be related. For example, the radial offset 280 can be half or about half (e.g., plus or minus 1-3%) of the radial offset 190). In an example implementation where the radial offset 190 is 45 degrees, the radial offset 280 is 22.5 degrees.

In some aspects, the radial offset 280 (in combination with the offset distance 261) can provide for or help ensure more efficient and smoother operation of the packer gear assembly 204. For example, at any moment of operation of the packer gear assembly 204 as the cog gears 208a and 208b are rotating (due to rotation of the shaft 226) to engage and urge the rack gears 209a and 209b (and subsequently the sled 211 and packer blade 206) rearward 114 or forward 116, these offsets provide for two independent lines of contact between the cog gears 208a and 208b and the rack gears 209a and 209b. The two independent lines of contact, which includes a first line between cog gear 208a and rack gear 209a and a second line between cog gear 208b and rack gear 209b, overlap such that different forces are being applied (by cog gears to rack gears) in the two lines of contact at any moment of operation. Though different such that force applied in the first line of contact can be less than (or greater than) the force applied in the second line of contact, forces are being applied in both lines of contact at any moment. Generally, the force applied in each line of contact can be represented by a sinusoidal wave (e.g., force applied by cog gear to rack gear vs. time).

In some aspects, these described lines of contact can help reduce slack in the movement of the rack gears 209a and 209b, which are rigidly connected (e.g., welded) to the sled 211 and thus rigidly coupled to the packer blade 206. By reducing slack, the packer blade 206 can have smoother movement in linear directions 114 and 116 during operation of the packer gear assembly 204. Further, by reducing chatter (or clanging between cog and rack gears), wear and tear on these components of the packer gear assembly 204 can be reduced. In addition, these lines of contact can focus a force applied by the cog gears 208a and 208b onto the rack gears 209a and 209b, respectively, in a substantively linear direction (in forces 199 and 198) rather than downward (in the direction of gravity), which would act to push the sled 211 (and, generally, the packer 130) downward.

In an example operation, the refuse collection vehicle 100 is moved (by an operator, autonomously, or semi-autonomously) into position such that refuse 990 is deposited into the hopper 124. Once sufficient refuse 990 collects in the hopper 124, the controller 150 (which can be communicably coupled to operate the packer prime mover 210) provides one or more control signals to operate the packer 130. Upon a command to execute a push in operation, the motor 222 can be activated to generate rotational power to the shaft 226 (e.g., through the gearbox 220). As the shaft 226 spins (in this example, counter clockwise), the cog gears 208a and 208b engage the rack gears 209a and 209b in the dual lines of contact as described. Rotational movement of the cog gears 208a and 208b is largely translated to a linear force 199, which is applied to the rack teeth 250a/250b of the respective rack gears 209a and 209b. Force 199 urges the rack gears 209a and 209b rearward 116 to urge the sled 211 (and packer blade 206) rearward 116 to push the refuse 990 into the storage container 120.

Once the packer blade 206 (or sled 211) has reached a particular location (or the cog gears 208a and 209b have reached an end of the rack gears 209a and 209b), the motor 222 can be switched to execute a pull in operation. The motor 222 can be activated to generate rotational power to the shaft 226 (e.g., through the gearbox 220). As the shaft 226 spins (in this example, clockwise), the cog gears 208a and 208b engage the rack gears 209a and 209b in the dual lines of contact as described. Rotational movement of the cog gears 208a and 208b is largely translated to a linear force 198, which is applied to the rack teeth 250a/250b of the respective rack gears 209a and 209b. Force 198 urges the rack gears 209a and 209b forward 114 to urge the sled 211 (and packer blade 206) forward 114 to reset the packer 130 for additional refuse 990.

Controllers, control units and/or computing devices described throughout this disclosure can include or employ one or more computing systems. FIG. 5 depicts an example computing system 500. The system 500 may be used for any of the operations or functions described in this disclosure with reference to a computing device. For example, the system 500 may be included, at least in part, in controller 150 and/or any other computing device(s) or system(s) associated with the refuse collecting vehicle 100. The system 500 includes one or more processors 510, a memory 520, one or more storage devices 530, and one or more input/output (I/O) devices controllable via one or more I/O interfaces 540. The various components 510, 520, 530, or 540 may be interconnected via at least one system bus 560, which may enable the transfer of data between the various modules and components of the system 500.

The system bus 560 may include a series of wired or wireless connections. In some implementations, the system bus includes a CAN network bus operating under the J1535 protocol.

The processor(s) 510 may be configured to process instructions for execution within the system 500. The processor(s) 510 may include single-threaded processor(s), multi-threaded processor(s), or both. The processor(s) 510 may be configured to process instructions stored in the memory 520 or on the storage device(s) 530. For example, the processor(s) 510 may execute instructions for the various software module(s) described herein. The processor(s) 510 may include hardware-based processor(s) each including one or more cores. The processor(s) 510 may include general purpose processor(s), special purpose processor(s), or both.

The memory 520 may store information within the system 500. In some implementations, the memory 520 includes one or more computer-readable media. The memory 520 may include any number of volatile memory units, any number of non-volatile memory units, or both volatile and non-volatile memory units. The memory 520 may include read-only memory, random access memory, or both. In some examples, the memory 520 may be employed as active or physical memory by one or more executing software modules.

The storage device(s) 530 may be configured to provide (e.g., persistent) mass storage for the system 500. In some implementations, the storage device(s) 530 may include one or more computer-readable media. For example, the storage device(s) 530 may include a floppy disk device, a hard disk device, an optical disk device, or a tape device. The storage device(s) 530 may include read-only memory, random access memory, or both. The storage device(s) 530 may include one or more of an internal hard drive, an external hard drive, or a removable drive.

One or both of the memory 520 or the storage device(s) 530 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 500. In some implementations, the CRSM may include a data store that provides storage of computer-readable instructions or other information in a non-transitory format. The CRSM may be incorporated into the system 500 or may be external with respect to the system 500. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, DRAM, and flash memory devices; magnetic disks such as internal hard disks and removable disks; magneto-optical disks; and CD-ROM and DVD-ROM disks. In some examples, the processor(s) 510 and the memory 520 may be supplemented by, or incorporated into, one or more application-specific integrated circuits (ASICs).

The system 500 may include one or more I/O devices (not shown). The I/O device(s) may include one or more input devices such as a joystick, keypad, keyboard, a mouse, a pen, a game controller, a touch input device (e.g., a touch pad), an audio input device (e.g., a microphone), a gestural input device, a haptic input device, an image or video capture device (e.g., a camera), a mobile device, or other devices. In some examples, the I/O device(s) may also include one or more output devices such as a display, LED(s), an audio output device (e.g., a speaker), a printer, a haptic output device, and so forth. The I/O device(s) may be physically incorporated in one or more computing devices of the system 500 or may be external with respect to one or more computing devices of the system 500.

The system 500 may include one or more I/O interfaces 540 to enable components or modules of the system 500 to control, interface with, or otherwise communicate with the I/O device(s). The I/O interface(s) 540 may enable information to be transferred in or out of the system 500, or between components of the system 500, through serial communication, parallel communication, or other types of communication. For example, the I/O interface(s) 540 may comply with a version of the RS-232 standard for serial ports, or with a version of the IEEE 1284 standard for parallel ports. As another example, the I/O interface(s) 540 may be configured to provide a connection over Universal Serial Bus (USB) or Ethernet. In some examples, the I/O interface(s) 540 may be configured to provide a serial connection that is compliant with a version of the IEEE 1354 standard.

The I/O interface(s) 540 may also include one or more network interfaces that enable communications between computing devices in the system 500, or between the system 500 and other network-connected computing systems. The network interface(s) may include one or more network interface controllers (NICs) or other types of transceiver devices configured to send and receive communications over one or more communication networks using any network protocol.

Computing devices of the system 500 may communicate with one another, or with other computing devices, using one or more communication networks. Such communication networks may include public networks such as the internet, private networks such as an institutional or personal intranet, or any combination of private and public networks. The communication networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 500 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

For example, although the vehicle described above is a refuse collection vehicle referred to as “garbage truck” that collects refuse or garbage, in some implementations, such a vehicle is designed to collect a variety of different types of used or discarded materials—e.g., recyclables, hazardous materials, construction materials, etc.

As another example, although the cab of the refuse vehicle is described above as featuring a compartment for a human driver, in some implementations, the refuse vehicle can be operated autonomously or semi-autonomously, or a combination thereof.

As yet another example, some implementations of this disclosure can be implemented without a mobile vehicle chassis. For instance, the storage container and packer can be fixed in place on a ground surface.

As yet another example, although the refuse vehicle is described above as having side-loading lift, in some implementations, the refuse vehicle may have a front-loading lift, and/or a rear-loading lift, or no lift at all.

As another example, although the described packer gear assembly includes a dual cog gear/rack gear arrangement, alternative implementations of the packer gear assembly can include a single cog gear/rack gear arrangement, a triple cog gear/rack gear arrangement, a quadruple cog gear/rack gear arrangement, and so on.

As yet another example, an addition to the above-described sensors for monitoring the lift, packer, and ejector, the refuse vehicle may further include sensors for monitoring a variety of other components, operations, and/or the vehicle’s surrounding environment. Such sensors may take a variety of forms. For example, the sensors can include, but are not limited to, an analog sensor, a digital sensor, a CAN bus sensor, a magnetostrictive sensor, a radio detection and ranging (RADAR) sensor, a light detection and ranging (LIDAR) sensor, a laser sensor, an ultrasonic sensor, an infrared (IR) sensor, a stereo camera, a three-dimensional (3D) camera, or a combination thereof.

As yet another example, the communicative coupling between the above-described logical controller (e.g., controller 150) and the packer gear assembly 204 may take a variety of forms. For instance, in some implementations, the logical controller provides command instructions to the drive, and those instructions trigger the drive to regulate operation of the packer. Alternatively, in some implementations, the logical controller provides command instructions to an energy source or intermediate controller—e.g., a battery pack, a converter (battery controller), or a hydraulic pump or valve)—that powers and regulates the drive.

As yet another example, in some implementations, packer load data may include the integrated, aggregated, or otherwise combined output of multiple different sensors monitoring various aspects of the packer. As yet another example, in some implementations, the packer load data output by the one or more sensors may include raw measured data and/or data pre-processed by the senor(s). As yet another example, in some implementations, data output from the one or more sensor(s) may be triggered by the occurrence of an event (e.g., activation of the packer), occur at predetermined time intervals, and/or occur in response to a received request (e.g., from the logical controller).

As yet another example, although the logical controller (e.g., controller 150) is described and illustrated above as operating the packer gear assembly 204, in some implementations the logical controller may be integrated with one or more other onboard computing devices that control different assemblies or systems of the vehicle chassis or refuse collecting body (e.g., the ejector, lift, tailgate, etc.). As yet another example, although the logical controller is described and illustrated above as an onboard component, in some implementations, the controller may be implemented such that one or more of its processing or storage components resides at a remote location.

As yet another example, although the information network is described above as an onboard wired data bus, in some implementations, the network may take the form of a wireless network.

As yet another example, although the logical controller (e.g., controller 150) is described above as issuing control instructions/commands based on packer load data, in some implementations, the controller may be operable to issue such instructions/commands in response to user input and/or requests from a remote computing device.

In some implementations, the above-described refuse collection vehicle is an all-electric vehicle or an at least partially electric vehicle. For example, one or more (e.g., all) motive power elements, body controls, and sub-systems of the refuse collection vehicle can be electrically powered by onboard battery packs.

A number of implementations have been described. Nevertheless, it will be understood that various modifications can be made without departing from the spirit and scope of the disclosure. For example, example operations, methods, or processes described herein can include more steps or fewer steps than those described. Further, the steps in such example operations, methods, or processes can be performed in different successions than that described or illustrated in the figures. Accordingly, other implementations are within the scope of the following claims.

What is claimed is:

1. A refuse collection vehicle, comprising:
a vehicle chassis defining a forward direction and a rearward direction of travel;
a refuse body on the vehicle chassis, the refuse body comprising:
a hopper; and
a storage container rearward of the hopper, the storage container defining an enclosed volume for containing waste;
a packer coupled to the refuse body, the packer comprising:
at least one rack and cog gear assembly driveably coupled to a prime mover, each rack and cog gear assembly comprising a cog gear interfaced with a rack gear; and
a packer blade coupled to the at least two rack gears; and
a controller communicably coupled to the prime mover and configured to perform operations comprising:
operating the prime mover to rotatably drive the at least one cog gear interfaced with the at least one rack gear; and
based on the rotation of the at least one cog gear, linearly driving the at least one rack gears in a linear direction to urge the packer blade to transfer waste from the hopper into the storage container.

2. The refuse collection vehicle of claim 1, wherein the at least one rack and cog gear assembly comprises at least two rack and cog gear assemblies, each of the at least two rack and cog gear assemblies comprising the cog gear interfaced with the rack gear.

3. The refuse collection vehicle of claim 2, wherein the packer comprises a shaft coupled with the prime mover, and the at least two cog gears are rigidly mounted on the shaft and separated by a gap.

4. The refuse collection vehicle of claim 3, wherein the gap is defined by a dimension associated with a thickness of a cog tooth on one of the at least two cog gears.

5. The refuse collection vehicle of claim 3, wherein the at least two cog gears comprise:
a first cog gear rigidly mounted on the shaft and comprising a plurality of first cog gear teeth; and
a second cog gear rigidly mounted on the shaft and comprising a plurality of second cog gear teeth, the second cog gear radially offset from the first cog gear such that each of the second cog gear teeth is radially offset from a radially adjacent first cog gear tooth by a radial offset.

6. The refuse collection vehicle of claim 5, wherein each first cog gear tooth is radially spaced apart from adjacent first cog gear teeth on the first cog gear by a radial distance, and each second cog gear tooth is radially spaced apart from adjacent second cog gear teeth on the second cog gear by the radial distance.

7. The refuse collection vehicle of claim 6, wherein the radial offset is half of the radial distance.

8. The refuse collection vehicle of claim 5, wherein the at least two rack gears comprise:
a first rack gear coupled to the packer blade and comprising a plurality of first rack gear teeth; and
a second rack gear coupled to the packer blade and comprising a plurality of second rack gear teeth, each of the second rack gear teeth linearly offset from a side adjacent first rack gear tooth by a linear offset.

9. The refuse collection vehicle of claim 8, wherein each of the first and second rack gears comprises a plurality of shoulder slopes defined between adjacent first rack teeth and adjacent second rack teeth, respectively.

10. The refuse collection vehicle of claim 1, wherein the linear direction is a first linear direction in the rearward direction of travel, and the operations comprise:
operating the prime mover to rotatably drive the at least one cog gear interfaced with the at least one rack gear; and
based on the rotation of the at least one cog gear, linearly driving the at least one rack gear in a second linear direction to urge the packer blade into a reset position, the second linear direction opposite the first linear direction and in the forward direction of travel.

11. A method of managing waste, comprising:
operating a refuse collection vehicle to move to a waste collection location, the refuse collection vehicle comprising:
a vehicle chassis defining a forward direction and a rearward direction of travel;
a refuse body on the vehicle chassis, the refuse body comprising:
a hopper;
a storage container rearward of the hopper, the storage container defining an enclosed volume for containing waste; and
a lift configured to service a refuse container proximate the vehicle; and
a packer coupled to the refuse body, the packer comprising:
at least one rack and cog gear assembly driveably coupled to a prime mover, the at least one rack and cog gear assembly comprising a cog gear interfaced with a rack gear; and
a packer blade coupled to the at least two rack gears;
operating the lift to engage the container, lift the container, and deposit waste from the container into the hopper;
operating the prime mover to rotatably drive the at least one cog gear interfaced with the at least one rack gear; and
based on the rotation of the at least one cog gear, linearly driving the at least one rack gear in a linear direction to urge the packer blade to transfer waste from the hopper into the storage container.

12. The method of claim 11, wherein the at least one rack and cog gear assembly comprises at least two rack and cog gear assemblies, each of the at least two rack and cog gear assemblies comprising the cog gear interfaced with the rack gear, the method comprising
operating the prime mover to rotatably drive the at least two cog gears interfaced with the at least two rack gears.

13. The method of claim 12, wherein operating the prime mover to rotatably drive the at least two cog gears comprises rotating a shaft with the prime mover to rotate the at least two cog gears rigidly mounted on the shaft and separated by a gap.

14. The method of claim 13, comprising rotating the shaft with the prime mover to rotate the at least two cog gears rigidly mounted on the shaft to engage the at least to rack gears without cross-engaging the at least two cog gears with the at least two rack gears due to the gap that is defined by a dimension associated with a thickness of a cog tooth on one of the at least two cog gears.

15. The method of claim 13, wherein operating the prime mover to rotatably drive the at least two cog gears comprises:
operating the prime mover to rotatably drive a first cog gear rigidly mounted on the shaft and comprising a plurality of first cog gear teeth; and
operating the prime mover to rotatably drive a second cog gear rigidly mounted on the shaft and comprising a plurality of second cog gear teeth, the second cog gear radially offset from the first cog gear such that each of the second cog gear teeth is radially offset from a radially adjacent first cog gear tooth by a radial offset.

16. The method of claim 15, wherein each first cog gear tooth is radially spaced apart from adjacent first cog gear teeth on the first cog gear by a radial distance, and each second cog gear tooth is radially spaced apart from adjacent second cog gear teeth on the second cog gear by the radial distance.

17. The method of claim 16, wherein the radial offset is half of the radial distance.

18. The method of claim 15, wherein linearly driving the at least two rack gears comprises:
linearly driving a first rack gear coupled to the packer blade and comprising a plurality of first rack gear teeth; and
linearly driving a second rack gear coupled to the packer blade and comprising a plurality of second rack gear teeth, each of the second rack gear teeth linearly offset from a side adjacent first rack gear tooth by a linear offset.

19. The method of claim 17, wherein each of the first and second rack gears comprises a plurality of shoulder slopes defined between adjacent first rack teeth and adjacent second rack teeth, respectively, and the method comprises:
facilitating egress of waste from the at least two rack gears, down at least one of the plurality of shoulder slopes, to a sump area under the at least two rack and cog gear assemblies.

20. The method of claim 11, wherein the linear direction is a first linear direction in the rearward direction of travel, and the method comprises:
operating the prime mover to rotatably drive the at least one cog gear interfaced with the at least one rack gear; and
based on the rotation of the at least one cog gear, linearly driving the at least one rack gear in a second linear direction to urge the packer blade into a reset position, the second linear direction opposite the first linear direction and in the forward direction of travel.

21. A packer for a refuse collection vehicle, comprising:
a housing or framework configured to couple to the refuse collection vehicle:
a prime mover assembly comprising a prime mover;
at least one rack and cog gear assembly driveably coupled to the prime mover assembly through a shaft and at least partially enclosed in the housing, the at least one rack and cog gear assembly comprising a cog gear interfaced with a rack gear and configured to impart linear force to the rack gear based on rotation of the cog gear on the shaft; and
a packer blade coupled to the rack gear and configured to move refuse based on movement of the rack gear in response to the linear force.

22. The packer of claim 21, wherein the at least one rack and cog gear assembly comprises:
a first rack and cog gear assembly that comprises a first rack gear and a first cog gear; and
a second rack and cog gear assembly that comprises a second rack gear and a second cog gear.

23. The packer of claim 22, wherein the first and second cog gears are rigidly mounted on the shaft and separated by a gap.

24. The packer of claim 23, wherein the gap is defined by a dimension associated with a thickness of a cog tooth on one of the first or second cog gears.

25. The packer of claim 23, wherein:
the first cog gear is rigidly mounted on the shaft and comprises a plurality of first cog gear teeth; and
the second cog gear is rigidly mounted on the shaft and comprises a plurality of second cog gear teeth, the second cog gear radially offset from the first cog gear such that each of the second cog gear teeth is radially offset from a radially adjacent first cog gear tooth by a radial offset.

26. The packer of claim 25, wherein each first cog gear tooth is radially spaced apart from adjacent first cog gear teeth on the first cog gear by a radial distance, and each second cog gear tooth is radially spaced apart from adjacent second cog gear teeth on the second cog gear by the radial distance.

27. The packer of claim 26, wherein the radial offset is half of the radial distance.

28. The packer of claim 25, wherein:
the first rack gear is coupled to the packer blade and comprises a plurality of first rack gear teeth; and
the second rack gear is coupled to the packer blade and comprises a plurality of second rack gear teeth, each of the second rack gear teeth linearly offset from a side adjacent first rack gear tooth by a linear offset.

29. The packer of claim 28, wherein each of the first and second rack gears comprises a plurality of shoulder slopes defined between adjacent first rack teeth and adjacent second rack teeth, respectively.

30. The packer of claim 21, wherein the prime mover assembly comprises an electric motor and a gear box.
